(19) United States
(12) Patent Application Publication
(10) Pub. No.: US 2006/0130496 A1
(43) Pub. Date: Jun. 22, 2006

(54) ENHANCED DIAGNOSTICS FOR A HEATING, VENTILATION AND AIR CONDITIONING CONTROL SYSTEM AND AN ASSOCIATED METHOD OF USE

(75) Inventors: John Chapman, Delaware, OH (US); Robert Burt, Columbus, OH (US); Yelena N. Kaplan, Columbus, OH (US); Stephen Joseph Vendt, Tyler, TX (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: RANCO INCORPORATED OF DELAWARE, Wilmington, DE (US)

(21) Appl. No.: 10/906,526

(22) Filed: Feb. 23, 2005

Related U.S. Application Data
(60) Provisional application No. 60/637,170, filed on Dec. 17, 2004.

(51) Int. Cl. F24F 7/00; F25B 49/00; G05D 23/32

(52) U.S. Cl. 62/126; 62/158; 236/1 C

(57) ABSTRACT

A heating, ventilation and air conditioning diagnostic system and associated method of use is disclosed. The system includes a controller for operating a heating, ventilation and air conditioning system, a plurality of sensors for monitoring various parameters associated with the operation of the heating, ventilation and air conditioning system that are in electronic communication with the controller, at least one input device that is in electronic communication with the controller, wherein the at least one input device is able to modify variables utilized by the controller to improve performance of the heating, ventilation and air conditioning system; and at least one output device that is in electronic communication with the controller. The variables can include non-safety timing values and text-based information. The system may include counters that can be read-only, reset to zero and overwritten through the plurality of input devices. Historical data can be recorded, reviewed and selectively analyzed.

### CROSS-REFERENCE TO RELATED APPLICATION

This patent application claims priority to U.S. Provisional Patent Application Ser. No. 60/637,170 filed Dec. 17, 2004.

### BACKGROUND OF THE INVENTION

A major problem associated with current heating, ventilation and air conditioning (“HVAC”) systems is that it is very difficult to customize non-safety timing values once a controller for an HVAC system is installed in the field for a particular application.

Examples of such timing values include, but are not limited to, the temperature differential for water heater applications and air circulator blower delay times for furnace applications.

Although the ability to ascertain real-time data from an HVAC system as well as view historical data, it is very difficult to quickly ascertain exactly when certain problems and defaults have occurred without going back through a tremendous amount of data. It is the timed pattern of problems and defaults that typically provide clues as to causation. By having a service technician forced to look at a tremendous amount of recorded historical data will prevent him or her from readily diagnosing malfunctions and problems.

Another problem involving HVAC systems is the need for the service technician to obtain pertinent information to complete the task at hand without disturbing building owners or building operators. Also, there may be a need to perform research by the service technician to complete his or her job. Information of this nature can include the end user, the service company, the HVAC system manufacturer and information regarding a controller for the HVAC system.

An example of a furnace diagnostic system having the above deficiencies is described in U.S. Pat. No. 6,658,372, which issued on Dec. 2, 2003, to Robertshaw Controls Company, incorporated herein by reference, and also U.S. Pat. No. 6,535,838, which issued on Mar. 18, 2003, to Robertshaw Controls Company, incorporated herein by reference.

The present invention is directed to overcoming one or more of the problems set forth above.

### SUMMARY OF INVENTION

In one aspect of this invention, a heating, ventilation and air conditioning diagnostic system is disclosed. This system includes a controller for operating a heating, ventilation and air conditioning system, a plurality of sensors for monitoring various parameters associated with the operation of the heating, ventilation and air conditioning system that are in electronic communication with the controller, at least one input device that is in electronic communication with the controller, wherein the at least one input device is able to modify variables utilized by the controller to improve performance of the heating, ventilation and air conditioning system, and at least one output device that is in electronic communication with the controller.

Another aspect of this invention is that a heating, ventilation and air conditioning diagnostic system is disclosed. The system includes a controller for operating a heating, ventilation and air conditioning system, a plurality of sensors for monitoring various parameters associated with the operation of the heating, ventilation and air conditioning system that are in electronic communication with the controller, wherein data from the plurality of sensors can be recorded in the controller, at least one input device that is in electronic communication with the controller, wherein the at least one input device is able to modify variables utilized by the controller to improve performance of the heating, ventilation and air conditioning system, and at least one output device that is in electronic communication with the controller.

Yet another aspect of this invention is that a heating, ventilation and air conditioning diagnostic system is disclosed. The system includes a controller for operating a heating, ventilation and air conditioning system and the controller is in electronic communication with a plurality of counters, a plurality of sensors for monitoring various parameters associated with the operation of the heating, ventilation and air conditioning system that are in electronic communication with the controller, wherein data from the plurality of sensors can be recorded in the controller, at least one input device that is in electronic communication with the controller, wherein the at least one input device is able to modify variables utilized by the controller to improve performance of the heating, ventilation and air conditioning system, and at least one output device that is in electronic communication with the controller.

In yet another aspect of this invention, a method for utilizing a heating, ventilation and air conditioning diagnostic system is disclosed. The method includes utilizing a controller for operating a heating, ventilation and air conditioning system, monitoring various parameters from a plurality of sensors associated with an operation of the heating, ventilation and air conditioning system that are in electronic communication with the controller, providing electronic communication between at least one input device and the controller, providing electronic communication between at least one output device and the controller, and modifying variables utilized by the controller with the at least input device to improve performance of the heating, ventilation and air conditioning system.

In another aspect of the present invention, a method for utilizing a heating, ventilation and air conditioning diagnostic system is disclosed. The method includes utilizing a controller for operating a heating, ventilation and air conditioning system that is in electronic communication with a plurality of counters, monitoring various parameters from a plurality of sensors associated with an operation of the heating, ventilation and air conditioning system that are in electronic communication with the controller, recording data from the plurality of sensors in the controller, providing electronic communication between at least one input device and the controller, providing electronic communication between at least one output device and the controller, and modifying variables utilized by the controller with the at least input device to improve performance of the heating, ventilation and air conditioning system.

These are merely some of the innumerable aspects of the present invention and should not be deemed an all-inclusive listing of the innumerable aspects associated with the present invention. These and other aspects will become apparent to those skilled in the art in light of the following disclosure and accompanying drawings.

### BRIEF DESCRIPTION OF DRAWINGS

For a better understanding of the present invention, reference may be made to the accompanying drawings in which:

FIG. 1 is a block diagram of a diagnostic system for a heating, ventilation and air conditioning system (HVAC) in accordance with the present invention;

FIG. 2 is a graphical user interface screen that illustrates various system inputs and outputs for a controller of the heating, ventilation and air conditioning system (HVAC) in accordance with the present invention; and

FIG. 3 is a graphical user interface screen that visually illustrates a component, e.g., furnace, of the heating, ventilation and air conditioning system (HVAC) and associated inputs and outputs in accordance with the present invention.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures and components have not been described in detail so as to obscure the present invention.

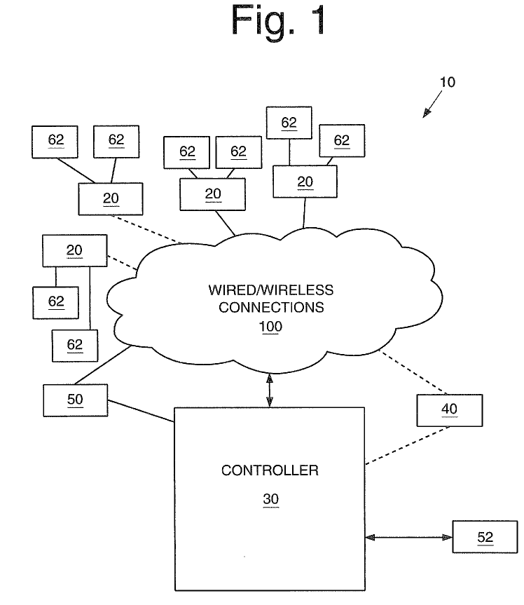

Referring now to FIG. 1, the present invention is directed to an electronic control system 10 for a heating, ventilation and air conditioning (“HVAC”) system. For the purposes of this patent application an HVAC system is broadly defined as system of heating, ventilation, evaporative cooling and/or air conditioning components, water heaters, as well as any combination thereof.

The electronic control system 10 includes at least one component of an HVAC system, e.g., furnace, which is generally indicated by numeral 20. A controller is generally indicated by numeral 30. The controller 30 can include a single processor or a whole series of processors and any variant of a processor such as a computer or a programmable logic controller.

The controller 30 is connected to at least one component 20, e.g., plurality of components, through any form of electronic communication 100. Also, the controller 30 can be an integral aspect of a particular component 20, e.g., furnace. This can include a hardwired connection indicated by solid lines or wireless communication indicated by dotted lines. This can also include a computer network. Preferably, the computer network is local in nature such as a local area network (LAN). However, a wide area network (WAN) and other types of computer networks are possible.

When using a LAN networking environment, the controller 30 is connected to the LAN through a network interface or adapter. When using a WAN networking environment, the controller 30 typically includes a modem or other means for establishing communications over the WAN, such as a global computer network e.g., the Internet. The WAN network permits communication to other points or systems with a more comprehensive computer network. The computer network is capable of communicating in a wide variety of methods including, but not limited to, point-to-point, star, mesh or star-mesh architecture. The protocols utilized can include, but are not limited to, proprietary, Internet, contention and polled protocols and their derivatives. Communication protocols can also include, but are not limited to, RS485 and RS232.

As an optional embodiment, additional processing capability 52 can be connected in electronic communication to the controller 30. An illustrative, but nonlimiting example, of this type of additional processing capability 52 includes a daughter board. This electronic communication 100 can be in the form of either hard-wired, wireless-type communication and any variant thereof.

Each component 20 preferably, but not necessarily, is in electronic communication 100 with a plurality of inputs 62, e.g., sensors. There are input and/or output devices 50, 40 in electronic communication 100 with the electronic control system 10. This can include an input and/or output device 50 that is connected via hardwired connections to the controller 30. Optionally, the input and/or output device 40 that is connected via wireless communication to the controller 30.

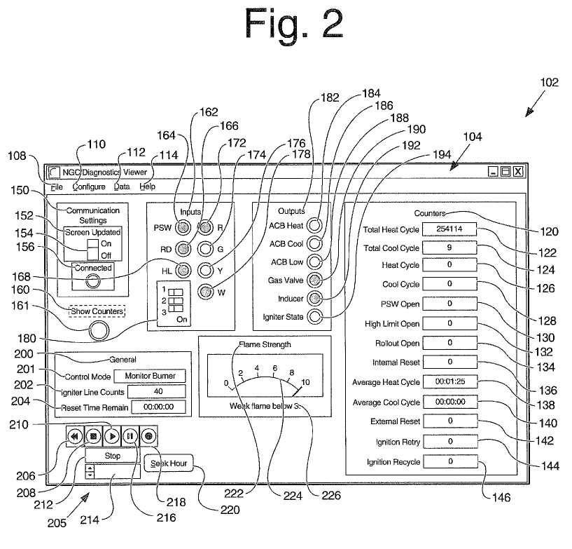

Although a thermostat is preferred, the input and/or output devices 50, 40 can include virtually any type of electronic output device. Preferably, but not necessarily, the electronic output device includes an electronic display 102, as shown in FIG. 2. Although a liquid crystal diode display is preferred for the electronic display 102, a cathode ray tube, a plasma screen and virtually any other type of electronic display will suffice. The electronic display 102 can be hard wired, portable or in wireless connection with the controller 30 and any combination thereof.

The input and/or output devices 50, 40 can also include an alarm to detect abnormal operating conditions or failures on part of the subsystems that can be visual or audible or both visual and audible. The alarm can be both local or over a computer network. If the alarm is over a computer network then nodes on the computer network will be able to visually or audibly indicate the alarm condition through controlled systems, subsystems and processes. Use of a wide area network, WAN, will permit safety and lower level alarm conditions to reach nodes that can provide an emergency response, monitoring services, owners, operators, repair and servicing organizations, and so forth. In premise nodes, such as that found on a local area network, LAN, the input and/or output devices 50, 40 can include, in addition to a thermostat, appliances, messaging terminals, personal computers, televisions, auxiliary smoke and fire monitors, and alarm mechanisms, and so forth.

Moreover, the input and/or output devices 50, 40 can include any type of pushbutton entry system including, but not limited to, a keyboard, voice recognition, and so forth. This can include, but is not limited to, a television set interface, and a security alarm display. Specifically the wireless input and/or output devices 40 can include, but are not limited to global computer network enabled appliance, e.g., web appliance, telephone (wired or wireless), personal digital assistant (“PDA”), laptop computer, home control interface and a wide variety of devices that use Wireless Application Protocol (“WAP”). WAP is a secure specification that allows users to access information instantly via handheld wireless devices. Wireless communication can also include infra-red communications.

Information from the plurality of inputs 62, e.g., sensors, can be recorded as historical data in the controller 30 as well as accessed and viewed in real-time with the input and/or output device 50, 40. Illustrative, but nonlimiting examples of this type of read-only data includes: status of a thermostat or a plurality of terminals for a thermostat and associated fuse status; a pressure switch input status; a high limit switch input status; a rollout switch input status; an inducer relay status; a gas valve relay status; a circulation blower relay status; a circulation blower heat relay status; a circulation blower cool relay status; an igniter triac status; a current mode for the controller 30; an igniter active line counts; and a time left auto-reset timer. A listing of these preferred inputs are listed below in Table 1. The access indication “R” means that the user through the input and/or output devices 50, 40 can only view the status of an input or output devices 50, 40 for the controller 30 and cannot change it.

TABLE 1

| Access | Inputs and Outputs for Controller 30 |
|---|---|
| R | Thermostat (Terminal W) Status |
| R | Thermostat (Terminal Y) Status |
| R | Thermostat (Terminal G) Status |
| R | Thermostat (Terminal R) Status and Fuse Status |
| R | Pressure Switch Input Status |
| R | High Limit Switch Input Status |
| R | Rollout Switch Input Status |
| R | Inducer Relay Status |
| R | Gas Valve Relay Status |
| R | Circulation Blower Relay Status |
| R | Circulation Blower Heat Relay Status |
| R | Circulation Blower Cool Relay Status |
| R | Igniter Triac Status |
| R | Current Mode of Controller 30 |
| R | Igniter Active Line Counts |
| R | Time Left Auto-Reset Timer |

An aspect of the present invention is information that can be stored in memory for the controller 30 and either accessed and in some instances accessed and modified through the input and/or output devices 50, 40. Illustrative, but nonlimiting examples of read-only data of this type includes: controller 30 information, e.g., manufacturing identification of the controller 30, model number of the controller 30, serial number of the controller 30, software revision of the controller 30, and a date code for the controller 30, e.g., date of origination for the controller 30, and system manufacturing information for the controller 30.

Illustrative, but nonlimiting examples of this type of data that can be read as well as modified includes: dealer information for the component 20, e.g., furnace. Nonlimiting examples of this type of information includes name of a dealer, phone number of a dealer, installation date for the component 20, e.g., furnace, and service dates for the component 20, e.g., furnace, and customer information, e.g., customer's name, address and zip code.

A listing of this data is provided below in Table 2. The access indication “R” means that the user through the input and/or output devices 50, 40 can only view the value and cannot change it. Access indication “W” indicates that the user through the input and/or output devices 50, 40 can alter the value to any desired value.

TABLE 2

| Access | Command | Purpose |
|---|---|---|
| R, W | Customer | Name, Address and Zip Code |
| | Information | |
| R | Controller | Manufacturing |
| | Information | Identification, Model |
| | | Number, Serial Number, |
| | | Software Revision, |
| | | and Date Code |
| R, W | Dealer Information | Name, Phone Number, |
| | | Installation and |
| | | Service Date |
| R | System | System Manufacturing Information |
| | Manufacturing | |
| | Information | |

Another aspect of this Invention is that information from the plurality of inputs 62, e.g., sensors, can be tallied or summed through counting-type electronic devices, e.g., counters.

Illustrative, but nonlimiting examples of this type of summed or tallied read-only data includes: a total number of heating cycles from flame detected to the flame not being present; a current mode of the controller 30; a total number of cooling cycles from when cooling is detected to when cooling is no longer present (such as found by detecting electrical power to the compressor from a specific terminal on the thermostat); and a current time stamp for the electronic control system 10.

Illustrative, but nonlimiting examples of this type of summed or tallied data that can be read as well as the counter, timer or event tally reset to zero (0) includes: a total number of the heating cycles since the counter or tally is cleared; a total number of the cooling cycles since the counter or tally is cleared; a number of pressure switch openings after a flame is sensed since the counter or tally is cleared; a number of high limit switch openings since the counter or tally is cleared; a number of rollout switch openings since the counter or tally is cleared; a number of internal resets since the counter or tally is cleared; an average time for a heating cycle; an average time for a cooling cycle; an average number of reset commands since the system has been cleared; and a failure history with a previous predetermined number, e.g., 20, of failures indicated with a time stamp.

Illustrative, but nonlimiting examples of this type of summed or tallied data that can be read as well as set to a desired value by the user, includes: at least one timing delay for turning the heat on; at least one timing delay for turning the heat off; at least one timing delay for turning the cooling on; and at least one timing delay for turning the cooling off.

A listing of this timer data is provided below in Table 3. The access indication “R” means that the user through the input and/or output devices 50, 40 can only view the value and cannot change it. Access indication “W” indicates that the user through the input and/or output devices 50, 40 can alter the value to any desired value. The access indication “Z” means that the user through the input and/or output devices 50, 40 can reset the counter, timer or event tally to zero (0).

TABLE 3

| Access | Property Name |
|---|---|
| R | Total Number of Heating Cycles |
| | (Flame Detected To Not Flame Present) |
| R | Total Number of Cooling Cycles |
| | (Power to Terminal Y Detected To |
| | Power Applied to Terminal Y Not |
| | Present) |
| R, Z | Total Number of Heating Cycles Since |
| | Cleared |
| R, Z | Total Number of Cooling Cycles Since |
| | Cleared |
| R | Current Mode of the Controller 30 |
| R, Z | Number of Pressure Switch Openings |
| | After a Flame is Sensed |
| R, Z | Number of High Limit Switch Openings |
| R, Z | Number of Rollout Switch Openings |
| R, Z | Number of Internal Resets |
| R, Z | Average Time for a Heating Cycle |
| R, Z | Average Time for a Cooling Cycle |
| R, Z | Number of Reset Commands Since the |
| | System Has Been Cleared |
| R, W | Heat On Delay Timing |
| R, W | Heat Off Delay Timing (Number 1) |
| R, W | Heat Off Delay Timing (Number 2) |
| R, W | Heat Off Delay Timing (Number 3) |
| R, W | Heat Off Delay Timing (Number 4) |
| R, W | Cool On Delay Timing |
| R, W | Cool Off Delay Timing (Number 1) |
| R, W | Cool Off Delay Timing (Number 2) |
| R | Current System Time Stamp |
| R, Z | Failure History - Previous |
| | Predetermined Number of Errors With |
| | Time Stamp |

Referring now to FIG. 2, the electronic display 102 can provide a graphical user interface screen 104 that provides a significant amount of visual information for the user. In an illustrative, but nonlimiting example, a graphical user interface screen 104 for a furnace system is depicted. There are click-on tabs for the graphical user interface screen 104 for the user to access other portions of the software with examples being a file function 108, a configure function 110, a data function 112 and a help function 114.

There is a listing of running counters indicated by numeral 120. Illustrative, but nonlimiting examples of these counters include: a total number of heating cycles from flame detected to the flame not being present 122; a total number of cooling cycles from when cooling is detected to when cooling is no longer present (such as found by detecting electrical power to the compressor from a specific terminal on the thermostat) 124; a total number of the heating cycles since the counter or tally is cleared 126; a total number of the cooling cycles since the counter or tally is cleared 128; a number of pressure switch openings after a flame is sensed since the counter or tally is cleared 130; a number of high limit switch openings since the counter or tally is cleared 132; a number of rollout switch openings since the counter or tally is cleared 134; a number of internal resets since the counter or tally is cleared 136; an average time for a heating cycle 138; an average time for a cooling cycle 140; an average number of external reset commands since the system has been cleared 142; an number of time the ignition retried 144 and the number of ignition recycles 146. There is verbiage indicating whether the counters are to be displayed on the graphical user interface screen 160 and an associated visual indicator 161.

There is a display for inputs indicated by numeral 162. Illustrative, but nonlimiting examples of these inputs include: an indication that a pressure switch is activated 164; an indication that a rollout switch is activated 166; an indication that a high limit switch is activated 168; an indication of power being applied to a particular terminal, e.g., “R”, for a thermostat 172; an indication of power being applied to a particular terminal, e.g., “G”, for a thermostat 174; an indication of power being applied to a particular terminal, e.g., “Y”, for a thermostat 176; and an indication of power being applied to a particular terminal, e.g., “W”, for a thermostat 178. There is also a graphical indication of a series of delay timers being on or off as indicated by numeral 180.

There is a display for outputs indicated by numeral 182. Illustrative, but nonlimiting examples of these outputs include: a circulation blower for heating being operational 184; a circulation blower for cooling being operational 186; a circulation blower being operational at a low level 188; an indication that a gas valve is operational 190; an indication that an inducer is operational 192; and an indication of an igniter state 194.

There is a display for general information indicated by numeral 200. Illustrative, but nonlimiting examples of this type of information includes: a control mode 201, e.g., monitor a burner; igniter line counts 202, e.g., 40; and reset time remaining 204, e.g., zero.

There is a display representing an indication of furnace flame strength indicated by numeral 222. There is a graphical representation of a meter indicated by numeral 224. There is also verbiage that indicates that a weak flame is below a certain predetermined value, e.g., 226.

There is a display for communication settings indicated by numeral 150. This includes a visual display as to whether the screen update feature 152 is indicated as being on or off 154. There is a visual indication 156 that indicates whether a controller 30 is in electronic communication 100 with an input and/or output devices 50, 40.

Also present on the graphical user interface screen 104 is a device for reviewing historical data from the electronic control system 10 that is generally indicated by numeral 205. This includes a graphical interface pushbutton for a fast rewind of the historical data 206, a graphical interface pushbutton to stop playing the historical data 208, a graphical interface pushbutton to play the historical data 210, a graphical interface pushbutton to pause recording the historical data 216 and a graphical interface pushbutton for recording of the historical data 218. There is also a visual indicator for the specific function that is currently activated 212, e.g., stop, rewind, play, pause, fast forward or record. There is a graphical user interface pushbutton 220 to seek a particular hour of recorded historical data. There is also a multiplier function 214 to speed or slow down the recording and playback of historical data from the electronic control system 10 by a predetermined factor.

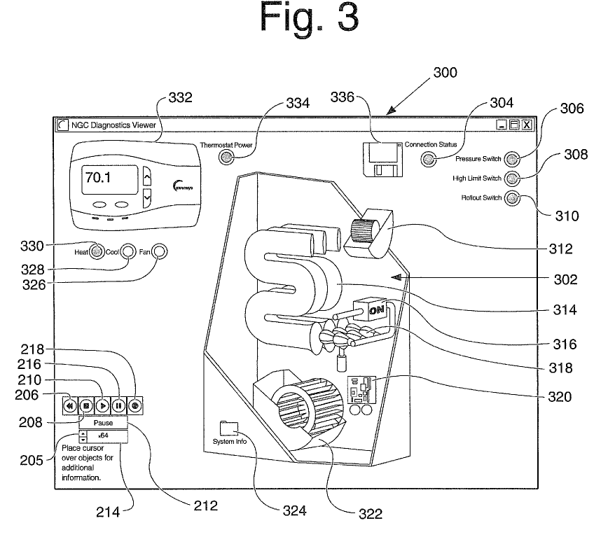

Information from the plurality of inputs 62, e.g., sensors, viewed in real-time with the input and/or output devices 50, 40, shown in FIG. 1, is preferably, but not necessarily, displayed with a graphical user interface screen 160 that replicates at least one component 20, e.g., furnace, and at least one of the plurality of inputs 62, e.g., sensors in FIG. 3. This graphical user interface screen 160 is generally indicated by numeral 300. There is a visual indicator 304 providing connection status between the controller 30 and an input and/or output devices 40, 50. There is a visual indicator 306 signifying if a pressure switch is open or closed. Also, there is a visual indicator 308 signifying if a high limit switch is open or closed. Furthermore, there is a visual indicator 310 signifying if a rollout switch is open or closed.

There is also a graphical representation of at least one component 20, e.g., furnace, indicated by numeral 302. Components of an illustrative furnace may include a first air circulator blower 312, an air duct 314, a gas valve 316, igniters 318 and a second air circulator blower 322. There is an icon for obtaining system information 324 and an icon for saving data 336. There is also a graphical representation of a control circuitry 320 for the at least one component 20, e.g., furnace.

In addition, there is the previous system for reviewing historical data from the electronic control system 10 (as shown in FIG. 1) that is generally indicated by numeral 205. This includes a graphical interface pushbutton for a fast rewind of the historical data 206, a graphical interface pushbutton to stop playing the historical data 208, a graphical interface pushbutton to play the historical data 210, a graphical interface pushbutton to pause recording the historical data 216 and a graphical interface pushbutton for recording of the historical data 218. There is also a visual indicator for the specific function that is currently activated 212, e.g., stop, rewind, play, pause, fast forward or record. There is also a multiplier function 214 to speed or slow down the recording and playback of historical data from the electronic control system 10 by a predetermined factor, e.g., 64.

In addition in FIG. 3, there is a visual representation 332 of an input and/or output devices 50, 40. An illustrative, but nonlimiting, example of an input and/or output devices 50, 40 includes a digital thermostat 332. There is a visual indicator 330 signifying whether heating is operational, a visual indicator 328 signifying whether cooling is operational and a visual indicator 326 signifying whether a fan is operational. Also, there is a visual indicator 334 indicating whether electrical power has been applied to the input and/or output devices 50, 40, e.g., digital thermostat 332.

The preferred embodiment of the present invention and the method of using the same has been described in the foregoing specification with considerable detail, it is to be understood that modifications may be made to the invention which do not exceed the scope of the appended claims and modified forms of the present invention performed by others skilled in the art to which the invention pertains will be considered infringements of this invention when those modified forms fall within the claimed scope of this invention.

What is claimed is:

1. A heating, ventilation and air conditioning diagnostic system comprising:
a controller for operating a heating, ventilation and air conditioning system;
a plurality of sensors for monitoring various parameters associated with the operation of the heating, ventilation and air conditioning system that are in electronic communication with the controller;
at least one input device that is in electronic communication with the controller, wherein the at least one input device is able to modify variables utilized by the controller to improve performance of the heating, ventilation and air conditioning system; and
at least one output device that is in electronic communication with the controller.

2. The heating, ventilation and air conditioning diagnostic system as set forth in claim 1, wherein the variables include non-safety, timing values.

3. The heating, ventilation and air conditioning diagnostic system as set forth in claim 1, wherein the at least one output device includes an electronic display.

4. The heating, ventilation and air conditioning diagnostic system as set forth in claim 2, wherein the non-safety, timing values are selected from the group consisting of at least one timing delay for turning heat on, at least one timing delay for turning heat off, at least one timing delay for turning cooling on, at least one timing delay for turning cooling off, a temperature differential value for a water heater and at least one timing delay for an air circulator blower.

5. The heating, ventilation and air conditioning diagnostic system as set forth in claim 1, further comprising indicating status of the plurality of sensors on the at least one output device is selected from the group consisting of status of at least one thermostat, status of at least one terminal from at least one thermostat, status of a fuse for at least one thermostat, status of a pressure switch, status of a rollout switch, status of a high limit switch, status of an inducer, status of a gas valve, status of an air circulation blower, status of an air circulation blower for heating, status of an air circulation blower for cooling, status of an igniter for the heating, ventilation and air conditioning system, status of active line counts for the controller, status of the controller and status of an automatically reset timer.

6. The heating, ventilation and air conditioning diagnostic system as set forth in claim 1, wherein the controller is in electronic communication with a plurality of counters, wherein information from at least one counter of the plurality of counters is displayed on the at least one output device.

7. The heating, ventilation and air conditioning diagnostic system as set forth in claim 6, wherein the plurality of counters includes a plurality of counters that provide read-only information.

8. The heating, ventilation and air conditioning diagnostic system as set forth in claim 7, wherein the plurality of counters that provide read-only information that is selected from the group consisting of a counter for tabulating a number of heating cycles, a counter for tabulating a number of cooling cycles, a counter indicating a current mode of operation for the controller and a counter that indicates a current system time stamp.

9. The heating, ventilation and air conditioning diagnostic system as set forth in claim 6, wherein the plurality of counters includes a plurality of counters that provide information that can be reset to a zero value.

10. The heating, ventilation and air conditioning diagnostic system as set forth in claim 9, wherein the plurality of counters that provide information can be reset to a zero value is selected from the group consisting of a counter for detecting a number of heating cycles, a counter for detecting a number of cooling cycles, a counter for detecting a number of pressure switch openings, a counter for detecting a number of high limit switch openings, a counter for detecting a number of rollout switch openings, a counter for detecting a number of resets, a counter for determining an average time for a heating cycle, a counter for determining an average time for a cooling cycle, a counter for determining a number of resets commands and a counter for determining a predetermined number of errors, and a counter for determining a predetermined number of errors associated with a system time stamp indication.

11. The heating, ventilation and air conditioning diagnostic system as set forth in claim 6, wherein the plurality of counters includes a plurality of counters that provide information that can be overwritten through the plurality of input devices and set to a specific value.

12. The heating, ventilation and air conditioning diagnostic system as set forth in claim 11, wherein the plurality of counters that provide information that can be overwritten through the plurality of input devices and set to a specific value is selected from the group consisting of at least one counter for a predetermined timing delay associated with turning heat on for the heating, ventilation and air conditioning system, at least one counter for a predetermined timing delay associated with turning heat off for the heating, ventilation and air conditioning system, at least one counter for a predetermined timing delay associated with turning cooling on for the heating, ventilation and air conditioning system, and at least one counter for a predetermined timing delay associated with turning cooling off for the heating, ventilation and air conditioning system.

13. The heating, ventilation and air conditioning diagnostic system as set forth in claim 1, wherein the variables include text-based information that is displayed on the at least one output device.

14. The heating, ventilation and air conditioning diagnostic system as set forth in claim 13, wherein the text-based information includes customer information that can be both read and revised.

15. The heating, ventilation and air conditioning diagnostic system as set forth in claim 14, wherein the customer information is selected from the group consisting of a customer's name, a customer's address, a customer's zip code, a customer's phone number, a customer's facsimile number and a customer's e-mail address.

16. The heating, ventilation and air conditioning diagnostic system as set forth in claim 13, wherein the text-based information includes dealer information for dealers of heating, ventilation and air conditioning systems that can be both read and revised.

17. The heating, ventilation and air conditioning diagnostic system as set forth in claim 16, wherein the dealer information is selected from the group consisting of a dealer's name, a dealer's address, a dealer's zip code, a dealer's phone number, a dealer's facsimile number, a dealer's e-mail address, an installation date for the heating, ventilation and air conditioning system and at least one service date for the heating, ventilation and air conditioning system.

18. The heating, ventilation and air conditioning diagnostic system as set forth in claim 13, wherein the text-based information includes information regarding the controller that is read-only.

19. The heating, ventilation and air conditioning diagnostic system as set forth in claim 18, wherein the information regarding the controller that is read-only is selected from the group consisting of a manufacturer's identification number, a model number for the heating, ventilation and air conditioning system, a serial number for the heating, ventilation and air conditioning system, a software revision number for the heating, ventilation and air conditioning system and a date code for the heating, ventilation and air conditioning system.

20. The heating, ventilation and air conditioning diagnostic system as set forth in claim 13, wherein the text-based information includes information regarding a manufacturer of the heating, ventilation and air conditioning system that is read-only.

21. A heating, ventilation and air conditioning diagnostic system comprising:
a controller for operating a heating, ventilation and air conditioning system;
a plurality of sensors for monitoring various parameters associated with the operation of the heating, ventilation and air conditioning system that are in electronic communication with the controller, wherein data from the plurality of sensors can be recorded in the controller;
at least one input device that is in electronic communication with the controller, wherein the at least one input device is able to modify variables utilized by the controller to improve performance of the heating, ventilation and air conditioning system; and
at least one output device that is in electronic communication with the controller.

22. The heating, ventilation and air conditioning diagnostic system as set forth in claim 21, wherein the data from the plurality of sensors recorded in the controller can be manipulated from the group consisting of playing back data, rewinding data, fast forwarding data, and pausing data with selected data displayed on the at least one output device.

23. The heating, ventilation and air conditioning diagnostic system as set forth in claim 22, wherein the manipulation of data can occur at speeds that are multiplied by a predetermined factor.

24. The heating, ventilation and air conditioning diagnostic system as set forth in claim 21, wherein predetermined events in the recorded data can be collected.

25. The heating, ventilation and air conditioning diagnostic system as set forth in claim 24, wherein the collected predetermined events in the recorded data can be time stamped.

26. The heating, ventilation and air conditioning diagnostic system as set forth in claim 21, wherein the data from the plurality of sensors recorded in the controller can be analyzed with respect to selected time periods.

27. A heating, ventilation and air conditioning diagnostic system comprising:
a controller for operating a heating, ventilation and air conditioning system and the controller is in electronic communication with a plurality of counters;
a plurality of sensors for monitoring various parameters associated with the operation of the heating, ventilation and air conditioning system that are in electronic communication with the controller, wherein data from the plurality of sensors can be recorded in the controller;
at least one input device that is in electronic communication with the controller, wherein the at least one input device is able to modify variables utilized by the controller to improve performance of the heating, ventilation and air conditioning system; and
at least one output device that is in electronic communication with the controller.

28. The heating, ventilation and air conditioning diagnostic system as set forth in claim 27, wherein the variables are selected from the group consisting of non-safety timing values and text-based information and the plurality of counters is selected from the group consisting of a plurality of counters that provide read-only information, a plurality of counters that provide information that can be reset to a zero value and a plurality of counters that provide information that can be overwritten through the at least one input device and set to a specific value and the data from the plurality of sensors recorded in the controller can be manipulated from the group consisting of playing back data, rewinding data, fast forwarding data, and pausing data, collecting at least one predetermined event and analyzing data with respect to selected time periods for display on the at least one output device.

29. A method for utilizing a heating, ventilation and air conditioning diagnostic system comprising:
utilizing a controller for operating a heating, ventilation and air conditioning system;
monitoring various parameters from a plurality of sensors associated with an operation of the heating, ventilation and air conditioning system that are in electronic communication with the controller;
providing electronic communication between at least one input device and the controller;
providing electronic communication between at least one output device and the controller; and
modifying variables utilized by the controller with the at least input device to improve performance of the heating, ventilation and air conditioning system.

30. A method for utilizing a heating, ventilation and air conditioning diagnostic system comprising:
utilizing a controller for operating a heating, ventilation and air conditioning system that is in electronic communication with a plurality of counters;
monitoring various parameters from a plurality of sensors associated with an operation of the heating, ventilation and air conditioning system that are in electronic communication with the controller;
recording data from the plurality of sensors in the controller;
providing electronic communication between at least one input device and the controller;
providing electronic communication between at least one output device and the controller; and
modifying variables utilized by the controller with the at least input device to improve performance of the heating, ventilation and air conditioning system.

31. The method for utilizing a heating, ventilation and air conditioning diagnostic system as set for in claim 30, wherein the variables are selected from the group consisting of non-safety timing values and text-based information and the plurality of counters is selected from the group consisting of a plurality of counters that provides read-only information, a plurality of counters that provides information that can be reset to a zero value and a plurality of counters that provides information that can be overwritten through the at least one input device and set to a specific value and the data from the plurality of sensors recorded in the controller can be manipulated from the group consisting of playing back data, rewinding data, fast forwarding data, and pausing data, collecting at least one predetermined event and analyzing data with respect to selected time periods for display on the at least one output device.
